(19) United States
(12) Patent Application Publication
(10) Pub. No.: US 2022/0128789 A1
(43) Pub. Date: Apr. 28, 2022

(54) FOLDABLE ANTI-LOST QUICKLY FOCUSED LASER APPARATUS

(71) Applicant: Dongguan Ortur Intelligent Technologies Co., Ltd., Dongguan (CN)

(72) Inventor: Weixu Zeng, Xinhua (CN)

(21) Appl. No.: 17/647,344

(22) Filed: Jan. 6, 2022

(30) Foreign Application Priority Data
Nov. 2, 2021 (CN) 202122652160.2

(51) Int. Cl. G02B 7/04; G02B 19/00

(52) U.S. Cl. CPC G02B 7/04; G02B 19/0047; G02B 19/0009

(57) ABSTRACT

The present invention discloses a foldable anti-lost quickly focused laser apparatus. The apparatus comprises a laser apparatus body. The laser apparatus body is provided with a focusing lifting lever. One side of the laser apparatus body is provided with a rotating shaft, and the focusing lifting lever is provided with an axle hole matched with the rotating shaft, so that the focusing lifting lever is rotatably arranged on the laser apparatus body. Furthermore, the laser apparatus body is provided with a fixing structure for fixing the focusing lifting lever on an upper side of the rotating shaft.

### BACKGROUND OF THE INVENTION

### 1. Technical Field

The present invention relates to the field of laser apparatuses, in particular to a foldable anti-lost quickly focused laser apparatus.

### 2. Description of Related Art

As a laser apparatus is lighter and lighter and smaller and smaller, more and more consumers take the laser apparatus as one of tools obtained by DW design. Before a laser operation, it is necessary to focus the laser apparatus and an operation material. However, an existing focusing mode is usually to measure a distance between the laser apparatus and the operation material with a focusing tool. The laser apparatus has the defects below: I, it is inconvenient to focus; and II, it is easy to lose the focusing tool.

Thus, it is necessary to research a novel technical scheme to solve the above-mentioned problem.

### BRIEF SUMMARY OF THE INVENTION

In order to understand defects and shortcomings in the prior art, the present invention provides a foldable anti-lost quickly focused laser apparatus. By arranging the focusing lifting lever on the laser apparatus body, it is easier, simpler and quicker compared with an existing focusing mode, and meanwhile, the trouble that the focusing tool is easy to lose is solved.

In order to achieve the objective, the present invention adopts a technical scheme below: a foldable anti-lost quickly focused laser apparatus includes a laser apparatus body, the laser apparatus body being provided with a focusing lifting lever, wherein

one side of the laser apparatus body is provided with a rotating shaft, and the focusing lifting lever is provided with an axle hole matched with the rotating shaft, so that the focusing lifting lever is rotatably arranged on the laser apparatus body;

furthermore, the laser apparatus body is provided with a fixing structure for fixing the focusing lifting lever on an upper side of the rotating shaft.

As a preferred scheme, one side of the laser apparatus body is provided with a vertically formed storage groove, and the rotating shaft is arranged in the storage groove.

As a preferred scheme, the storage groove is internally provided with an adsorption piece for fixing the focusing lifting lever, and the focusing lifting lever is made from an adsorbable material.

As a preferred scheme, the laser apparatus body is provided with a fixing structure for fixing the focusing lifting lever on an upper side of the rotating shaft.

As a preferred scheme, the side of the focusing lifting lever away from the storage groove is provided with a pressing portion in an extending manner.

As a preferred scheme, the pressing portion is formed by extending the focusing lifting lever obliquely towards the side away from the storage groove.

As a preferred scheme, the pressing portion is formed by extending the focusing lifting lever perpendicularly towards the side away from the storage groove.

As a preferred scheme, a pair of side walls of the storage groove each is provided with a mounting hole for mounting the rotating shaft, and during mounting, the axle hole of the focusing lifting lever corresponds to the mounting hole, and then the rotating shaft penetrates into one mounting hole and is limited by the other mounting hole, so that the focusing lifting lever is detachably connected to the laser apparatus body.

As a preferred scheme, a side wall of the storage groove is provided with a mounting recess for mounting the adsorption piece, and the adsorption piece is mounted in the mounting recess.

Compared with the prior art, the present invention has obvious advantages and beneficial effects. Specifically speaking, it may be known from the above-mentioned technical scheme that by mainly arranging the focusing lifting lever on the laser apparatus body, compared with an existing focusing mode, the apparatus has the advantages: 1. The focusing mode is easier, simpler and quicker; 2. A trouble that a focusing tool is easily lost is solved; 3. The fixing structure is arranged, so that it is convenient to store the focusing lifting lever, and the focusing lifting lever is further prevented from affecting normal work of the laser apparatus body; 4. By designing the focusing lifting lever specifically, the simplicity of the focusing operation is further improved; and 5. It is relatively simple in overall structure, easy to realize and suitable for being popularized and applied.

In order to explain structural features and functions of the present invention more clearly, further description in detail on the present invention will be made in combination with drawings and specific embodiments below.

### BRIEF DESCRIPTION OF THE SEVERAL VIEWS OF THE DRAWINGS

FIG. 1 is a stereogram of an embodiment of the present invention.

FIG. 2 is an exploded view of an embodiment of the present invention.

FIG. 3 is a cross section diagram of an embodiment of the present invention (focused state).

FIG. 4 is another cross section diagram of an embodiment of the present invention (stored state).

### DESCRIPTION OF NUMERALS IN DRAWINGS

10, laser apparatus body; 11, rotating shaft; 12, storage groove; 121, mounting hole; 13, adsorption piece; 20, focusing lifting lever; 21, axle hole; 22, pressing portion.

### DETAILED DESCRIPTION OF THE INVENTION

Clear and intact description will be made on technical scheme in the embodiment of the present invention below in combination with drawings. Apparently, the described embodiments are merely preferred embodiments of the present invention.

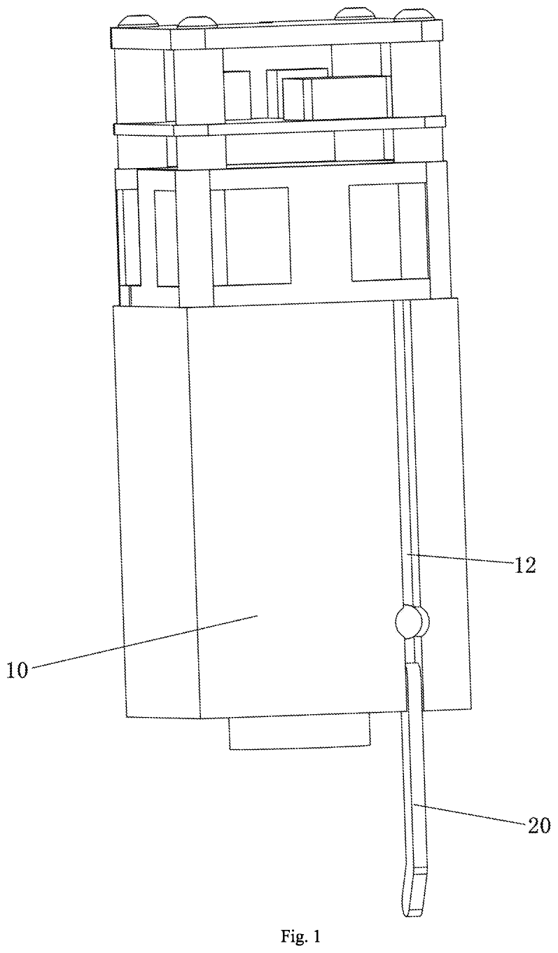

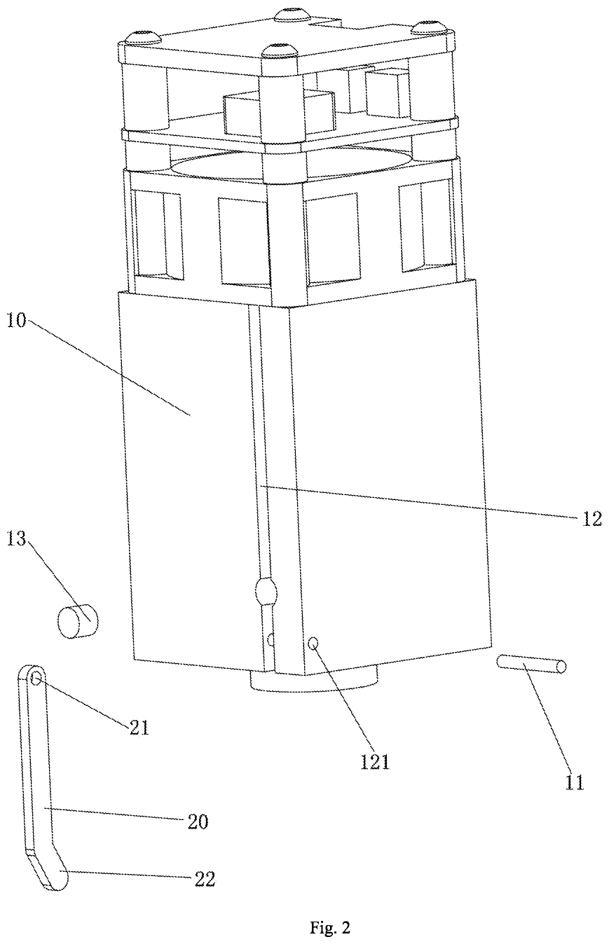

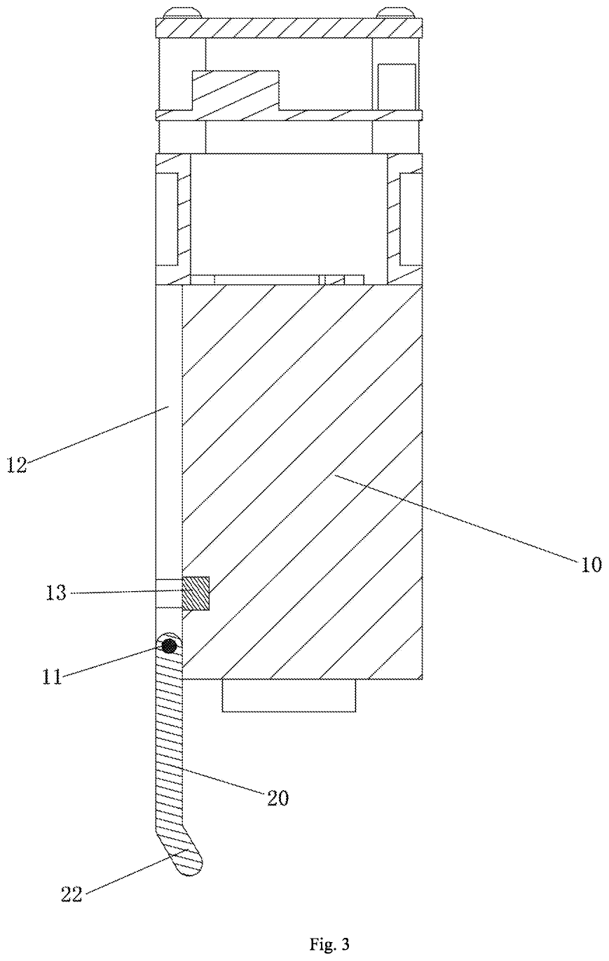

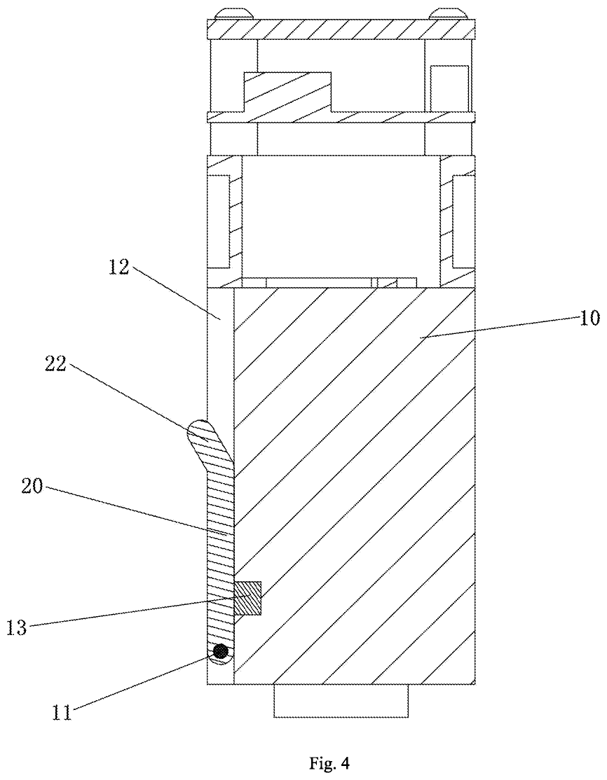

Referring to FIG. 1 to FIG. 4, a foldable anti-lost quickly focused laser apparatus in the embodiment of the present invention includes a laser apparatus body 10, the laser apparatus body 10 being provided with a focusing lifting lever 20, wherein

one side of the laser apparatus body 10 is provided with a rotating shaft 11, and the focusing lifting lever 20 is provided with an axle hole 21 matched with the rotating shaft 11, so that the focusing lifting lever 20 is rotatably arranged on the laser apparatus body 10; and

furthermore, the laser apparatus body 10 is provided with a fixing structure for fixing the focusing lifting lever 20 on an upper side of the rotating shaft 11.

During use, a laser focus sent by the laser apparatus body 10 is adjusted, so that the focus thereof and a user are to allocate the focusing lifting lever 20 to be in a vertical state, and the plane and the laser focus contacted at the lowest point is located in the same horizontal plane. Thus, the user can focus quickly. Compared with an existing focusing mode, the apparatus has the advantages: 1. The focusing mode is easier, simpler and quicker; 2. The A trouble that a focusing tool is easily lost is solved; 3. The fixing structure is arranged, so that it is convenient to store the focusing lifting lever 20, and the focusing lifting lever is further prevented from affecting normal work of the laser apparatus body 10.

Specifically speaking, one side of the laser apparatus body 10 is provided with a vertically formed storage groove 12, and the rotating shaft 11 is arranged in the storage groove 12.

Further, the storage groove 12 is internally provided with an adsorption piece 13 for fixing the focusing lifting lever 20, and correspondingly, the focusing lifting lever 20 is made from an adsorbable material. When being stored, the focusing lifting lever 20 is adsorbed to the adsorption piece 13. Usually, the adsorption piece 13 is a magnet.

Or, an upper side of the rotating shaft 11 in the storage groove 12 is provided with a buckling structure for fixing the focusing lifting lever 20. When being stored, the focusing lifting lever 20 is buckled in the buckling structure.

Preferably, the side of the focusing lifting lever 20 away from the storage groove 12 is provided with a pressing portion 22 in an extending manner. Thus, when being focused, a user only needs to press the pressing portion 22 with a finger, the focusing lifting lever 20 can be allocated, so that it is further more convenient to focus. Specifically, the pressing portion 22 is formed by extending the focusing lifting lever 20 obliquely towards the side away from the storage groove 12; or, the pressing portion 22 is formed by extending the focusing lifting lever 20 perpendicularly towards the side away from the storage groove 12.

In an actual application, a pair of side walls of the storage groove 12 each is provided with a mounting hole 121 for mounting the rotating shaft 11, and during mounting, the axle hole 21 of the focusing lifting lever 20 corresponds to the mounting hole 121, and then the rotating shaft 11 penetrates into one mounting hole 121 and is limited by the other mounting hole 121, so that the focusing lifting lever 20 is detachably connected to the laser apparatus body 10. Via the detachable design, when the focus lifting lever 20 is damaged or the user wants to replace other focusing modes, it can be detached and replaced correspondingly.

A side wall of the storage groove 12 is provided with a mounting recess for mounting the adsorption piece 13, and the adsorption piece 13 is mounted in the mounting recess.

The design keypoint of the present invention lies in that by mainly arranging the focusing lifting lever on the laser apparatus body, compared with an existing focusing mode, the apparatus has the advantages: 1. The focusing mode is easier, simpler and quicker; 2. A trouble that a focusing tool is easily lost is solved; 3. The fixing structure is arranged, so that it is convenient to store the focusing lifting lever, and the focusing lifting lever is further prevented from affecting normal work of the laser apparatus body; 4, by designing the focusing lifting lever specifically, the simplicity of the focusing operation is further improved; and 5, it is relatively simple in overall structure, easy to realize and suitable for being popularized and applied.

The above is merely preferred embodiments of the present invention and is not limited to the technical scope of the present invention. Any subtle modifications, equivalent changes and modifications made on the embodiments in accordance with the technical substance of the present invention shall come within the scope of the technical scheme of the present invention.

What is claimed is:

1. A foldable anti-lost quickly focused laser apparatus, characterized by comprising a laser apparatus body, the laser apparatus body being provided with a focusing lifting lever, wherein
one side of the laser apparatus body is provided with a rotating shaft, and the focusing lifting lever is provided with an axle hole matched with the rotating shaft, so that the focusing lifting lever is rotatably arranged on the laser apparatus body; and
furthermore, the laser apparatus body is provided with a fixing structure for fixing the focusing lifting lever on an upper side of the rotating shaft.

2. The foldable anti-lost quickly focused laser apparatus according to claim 1, characterized in that one side of the laser apparatus body is provided with a vertically formed storage groove, and the rotating shaft is arranged in the storage groove.

3. The foldable anti-lost quickly focused laser apparatus according to claim 2, characterized in that the storage groove is internally provided with an adsorption piece for fixing the focusing lifting lever, and the focusing lifting lever is made from an adsorbable material.

4. The foldable anti-lost quickly focused laser apparatus according to claim 2, characterized in that an upper side of the rotating shaft in the storage groove is provided with a buckling structure for fixing the focusing lifting lever.

5. The foldable anti-lost quickly focused laser apparatus according to claim 2, characterized in that the side of the focusing lifting lever away from the storage groove is provided with a pressing portion in an extending manner.

6. The foldable anti-lost quickly focused laser apparatus according to claim 5, characterized in that the pressing portion is formed by extending the focusing lifting lever obliquely towards the side away from the storage groove.

7. The foldable anti-lost quickly focused laser apparatus according to claim 5, characterized in that the pressing portion is formed by extending the focusing lifting lever perpendicularly towards the side away from the storage groove.

8. The foldable anti-lost quickly focused laser apparatus according to claim 2, characterized in that a pair of side walls of the storage groove each is provided with a mounting hole for mounting the rotating shaft, and during mounting, the axle hole of the focusing lifting lever corresponds to the mounting hole, and then the rotating shaft penetrates into one mounting hole and is limited by the other mounting hole, so that the focusing lifting lever is detachably connected to the laser apparatus body.

9. The foldable anti-lost quickly focused laser apparatus according to claim 3, characterized in that a side wall of the storage groove is provided with a mounting recess for mounting the adsorption piece, and the adsorption piece is mounted in the mounting recess.
